(19) United States
(12) Patent Application Publication
(10) Pub. No.: US 2026/0276452 A1
(43) Pub. Date: Sep. 17, 2026

(54) SILICON BASED DETECTION DEVICE WHICH DETECTS THE SHORT-WAVE INFRARED (SWIR) WAVELENGTHS

(71) Applicant: UltraSenIC Ltd., Haifa (IL)

(72) Inventors: Alexander KATZ, Binyamina (IL); Aleksey DYSKIN, Haifa (IL)

(73) Assignee: UltraSenIC Ltd., Haifa (IL)

(21) Appl. No.: 19/081,091

(22) Filed: Mar. 17, 2025

(51) Int. Cl. G01J 5/20; G01J 5/08

(52) U.S. Cl. CPC G01J 5/20; G01J 5/0814

(57) ABSTRACT

A system and method for frequency conversion of a Short-Wave Infrared (SWIR) signal utilizing a three-dimensional resonant optical structure are disclosed. The system comprises a silicon layer exhibiting third-order nonlinearity (χ(3)) positioned within a Fabry-Pérot cavity formed by dielectric reflectors. A pump wave and an input SWIR signal undergo Four-Wave Mixing (FWM) within the cavity, generating an idler wave at a converted wavelength. The idler wave is detected via a silicon electro-optical detector using two-photon absorption or free carrier absorption. The technology is applicable to SWIR imaging and optical communication, offering enhanced detection sensitivity in the infrared range while leveraging cost-effective silicon-based photonics.

### FIELD AND BACKGROUND OF THE INVENTION

The present invention, optionally, relates to infrared photonics and, more particularly, but not exclusively, to frequency conversion techniques in optoelectronics.

As used herein, the term “SWIR” means “short-wave infrared”.

SWIR radiation detection is a critical technology in applications such as imaging, remote sensing, optical communication, and spectroscopy. Traditional SWIR photodetectors are primarily based on compound semiconductors such as Indium Gallium Arsenide (InGaAs), Mercury Cadmium Telluride (MCT), and Cadmium Zinc Telluride (CdZnTe). These materials offer high quantum efficiency but present limitations in terms of fabrication complexity, cost, and integration with silicon-based platforms.

Recent advancements in emerging materials, such as GeSn alloys, organic small-molecule semiconductors, colloidal quantum dots, and metal-halide perovskites have demonstrated new potential for extending SWIR detection capabilities while improving integration with complementary metal-oxide-semiconductor (CMOS) technology. GeSn materials, for example, offer tunable bandgaps covering the entire SWIR spectrum, though challenges related to crystal quality, lattice mismatch, and Sn segregation remain. Solution-processed organic semiconductors have been explored as an alternative approach, enabling large-area, cost-effective SWIR photodiodes.

The increasing demand for SWIR radiation detection in areas such as hyperspectral imaging, defense, biomedical applications, and industrial inspection continues to drive research into novel device architectures.

These developments highlight the need for scalable, high-sensitivity SWIR photodetectors that can overcome the limitations of conventional materials while maintaining compatibility with silicon-based technologies.

### SUMMARY OF THE INVENTION

As used herein, the term “FWM” means “Four-Wave Mixing”.

According to an aspect of some embodiments of the present invention, there is provided a system for generating a frequency-converted optical signal from a SWIR input signal wave, the system comprising: a three-dimensional resonant optical structure, comprising a silicon layer exhibiting third-order nonlinearity (χ(3)); a first reflector and a second reflector, wherein the silicon layer is positioned between the first reflector and the second reflector, thereby forming a resonant cavity configured to support phase-matched nonlinear optical interactions; a pump generator, configured to generate a coherent electromagnetic pump wave at a controlled wavelength; and a silicon electro-optical detector, wherein the input signal wave and the pump wave undergo FWM within the silicon layer, thereby generating an idler wave at a converted wavelength, and wherein the electro-optical detector converts the idler wave into a corresponding electrical signal via a two-photon absorption mechanism and/or free carrier absorption.

Optionally, each of the first reflector and the second reflector comprises a plurality of dielectric layers.

Optionally, at least one dielectric layer in the plurality of dielectric layers is selected from the group consisting of a titanium dioxide layer, tantalum pentoxide layer, silicon nitride layer, and a silicon dioxide layer.

Optionally, each reflector comprises at least 10 dielectric layers, with the number of layers selected to achieve a desired reflectivity.

Optionally, the plurality of dielectric layers are deposited using a method selected from the group consisting of ion beam sputtering (IBS), ion-assisted electron beam deposition (IBAD), atomic layer deposition (ALD), and chemical vapor deposition (CVD).

Optionally, the SWIR input signal wave has a wavelength within a range of 1,500 nm to 1,850 nm, and the pump wave has a wavelength of 1,310 nm.

Optionally, the silicon layer has a thickness of 50 μm.

Optionally, the SWIR input signal wave has a wavelength of approximately 1.55 μm, optimized for optical communication applications.

Optionally, the pump wave has a wavelength within a range of 1,000 nm and 1,650 nm.

Optionally, the idler wave wavelength is tunable by adjusting the input signal wave wavelength.

Optionally, the signal and idler frequencies are configured to align with the longitudinal modes of the optical cavity, thereby enhancing phase matching and nonlinear conversion efficiency.

According to an aspect of some embodiments of the present invention, there is provided a system for generating a frequency-converted optical signal from a SWIR input signal wave, the system comprising: a three-dimensional resonant optical structure, comprising a silicon layer exhibiting third-order nonlinearity (χ(3)); a first reflector and a second reflector, wherein the silicon layer is positioned between the first reflector and the second reflector, thereby forming a resonant cavity configured to support phase-matched nonlinear optical interactions, wherein the input signal wave has sufficient optical power to undergo FWM within the silicon layer without requiring a pump wave, thereby generating an idler wave at a converted wavelength, enabling further processing or detection.

According to an aspect of some embodiments of the present invention, there is provided a method for generating a frequency-converted optical signal from a SWIR input signal wave, the method comprising: providing a three-dimensional resonant optical structure comprising a silicon layer exhibiting third-order nonlinearity (χ(3)); a first reflector and a second reflector, wherein the silicon layer is positioned between the first reflector and the second reflector, thereby forming a resonant cavity configured to support phase-matched nonlinear optical interactions; generating a coherent electromagnetic pump wave at a controlled wavelength using a pump generator; inputting the SWIR input signal wave and the pump wave into the three-dimensional resonant optical structure; facilitating FWM within the silicon layer between the input signal wave and the pump wave, thereby generating an idler wave at a converted wavelength; and converting the idler wave into a corresponding electrical signal with a silicon electro-optical detector via a two-photon absorption mechanism and/or free carrier absorption.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of the structure of a silicon-based SWIR detection device, according to some embodiments of the invention; and

FIG. 2 is a chart illustrating the dependence of idler wave power on the signal wavelength.

### DESCRIPTION OF SPECIFIC EMBODIMENTS OF THE INVENTION

The present invention, optionally, relates to infrared photonics and, more particularly, but not exclusively, to frequency conversion techniques in optoelectronics.

Optical detection and imaging in the SWIR range are essential for a variety of applications, including spectroscopy, remote sensing, night vision, biomedical diagnostics, and industrial quality control. Many conventional SWIR detection systems rely on compound semiconductors such as Indium Gallium Arsenide (InGaAs), Mercury Cadmium Telluride (MCT), and Cadmium Zinc Telluride (CdZnTe), which, while effective, introduce challenges related to fabrication complexity, cost, and scalability. This invention provides an alternative solution, enabling cost-effective, silicon-compatible SWIR photodetection while maintaining high sensitivity and performance.

According to one of the methods disclosed in the present application, infrared optical signals in the SWIR band are converted into a wavelength range that is more readily detectable by standard silicon-based photodetectors. The method described hereinbelow enables nonlinear frequency conversion in a silicon-based resonant cavity, leveraging FWM or other nonlinear optical interactions to generate an idler signal at a converted wavelength. The nonlinear interactions occur within a high-Q resonant optical cavity, ensuring efficient energy transfer and maximizing conversion efficiency.

By converting an incoming SWIR signal into a shorter, detectable wavelength, the invention enables the use of cost-effective, mass-producible silicon photodiodes or CMOS sensors. The system is applicable to LiDAR systems, medical imaging, range finder systems, robotics and optical communications, where compact and integrated detection solutions are required.

The present invention further provides several advantages in terms of safety, performance, and system integration. Operating in the SWIR range allows the use of eye-safe optical sources, enabling higher permissible optical power levels compared to visible and near-infrared sources, thereby enhancing detection sensitivity and signal-to-noise ratio. Additionally, SWIR operation inherently reduces background solar noise, improving system performance in outdoor and high-ambient-light environments.

Unlike conventional compound semiconductor-based SWIR detection systems, which require complex fabrication and specialized integration steps, the disclosed system maintains seamless compatibility with existing silicon photonics and CMOS platforms. This ensures full sensor-on-chip integration, enabling compact, scalable, and cost-effective solutions without compromising on performance. Moreover, the system requires no additional cost beyond existing commercial optical sensors, as it leverages well-established manufacturing processes.

The compact and integrated design allows the system to retain a regular form factor, eliminating the need for bulky or externally mounted optical components. Furthermore, due to the narrow-bandwidth characteristics of the optical cavity, the invention reduces reliance on additional optical filtering elements, simplifying system architecture and further minimizing cost and complexity. These benefits collectively enable high-performance, low-cost, and easily integrated SWIR detection solutions, suitable for a wide range of imaging, sensing, and communication applications.

One example use case involves autonomous navigation, where vehicles equipped with LiDAR systems utilizing SWIR laser sources can detect obstacles under low-visibility conditions. By shifting the detection wavelength into a range where affordable, high-resolution silicon-based detectors can be used, this invention significantly reduces system costs while maintaining high detection accuracy.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

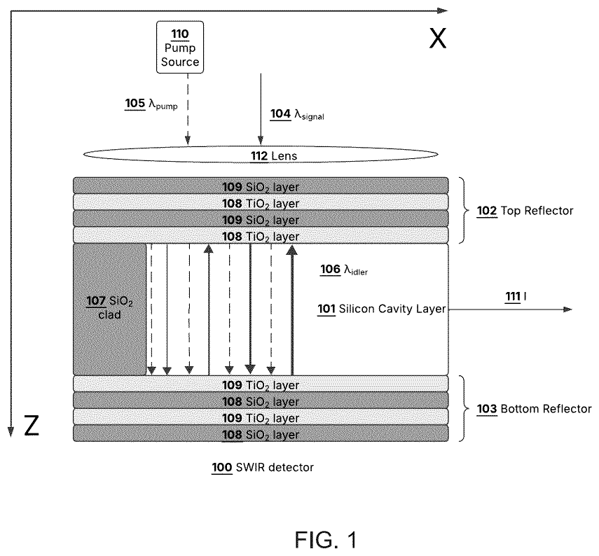

Referring now to the drawing, FIG. 1 illustrates the structure of a silicon-based SWIR detection device. According to some embodiments of the invention, the SWIR detector 100 comprises a pure silicon cavity layer 101 exhibiting third-order nonlinearity (χ(3)), which is placed between a top reflector 102 and a bottom reflector 103, together forming a Fabry-Pérot resonant cavity. The top and bottom reflectors 102, 103 are configured as high-reflectivity dielectric mirrors, designed to support constructive optical interference and phase-matched nonlinear optical interactions within the Fabry-Pérot cavity. In FIG. 1, the Z axis is parallel to the light propagation axis of the detection device, and is orthogonal to the mutually orthogonal X axis and Y axis (not shown).

Optionally, the detector 100 receives a SWIR signal wave 104, and further comprises a pump source 110 configured to generate a coherent electromagnetic pump wave 105 at a controlled wavelength.

Optionally, the detector 100 is configured to facilitate Four-Wave Mixing (FWM) within the cavity layer 101, leveraging third-order nonlinear optical interactions (χ(3)) to generate a frequency-converted idler wave. In operation, the SWIR signal wave 104 and the coherent pump wave 105 interact within the Fabry-Pérot resonant cavity, wherein the strong optical field enhancement enables energy transfer between the interacting waves. Through the FWM process, two photons from the pump wave 105 combine with one photon from the signal wave 104 to generate a new photon at the wavelength of an idler wave 106, satisfying the phase-matching condition:

$$2 {ω}_{p u m p} - {ω}_{s i g n a l} = {ω}_{i d l e r}$$

The Fabry-Pérot cavity structure ensures multiple round-trip interactions, reinforcing parametric gain and improving wavelength conversion efficiency.

Optionally, the input signal wave 104 has a wavelength within a range of 1500 nm to 1850 nm. In some embodiments, the input signal wave 104 has a wavelength of about 1550 nm, corresponding to the standard optical communication window, thereby enabling direct integration with fiber-optic networks, telecommunication systems, and infrared spectroscopy applications.

Optionally, the pump wave 105 has a wavelength within a range of 1000 nm to 1650 nm, selected based on the availability of commercially viable light sources and the phase-matching conditions to optimize energy transfer efficiency in the FWM process. In some embodiments, the pump wave 105 wavelength may be chosen as about 1310 nm or 1325.2 nm, as these values provide optimal enhancement factors for FWM within the Fabry-Pérot cavity. The selection of pump wave 105 wavelength influences the generated idler wave 106 wavelength, ensuring its detectability within a silicon-based photodetector such as the cavity layer 101.

Optionally, the idler wave 106 wavelength is tunable by adjusting the pump wave 105 wavelength, thereby enabling dynamic control over the frequency-conversion process. By varying the pump wave 105 wavelength, the idler wavelength can be selectively shifted across a predetermined spectral range, allowing for adaptive wavelength conversion based on operational requirements. This tunability is particularly advantageous for applications such as spectroscopy, hyperspectral imaging, and optical communication, where precise wavelength control is essential.

Optionally, the cavity layer 101 dimensions are configured to support efficient nonlinear optical interactions, enabling phase-matching conditions for FWM and ensuring optimal free spectral range (FSR), minimal optical losses, and a strong parametric amplification. The phase-matching condition is dictated by the resonant nature of the cavity, ensuring that the pump frequency aligns with longitudinal cavity modes, which is a prerequisite for maximizing nonlinear conversion efficiency.

Optionally, the cavity layer 101 has a thickness less or equal to 200 μm, ensuring effective coupling and phase coherence between interacting waves.

Optionally, the cavity layer 101 has a thickness of about 50 μm, enabling a high pump enhancement factor, ensuring an efficient energy buildup within the cavity layer 101, and maintaining a minimal phase mismatch among interacting waves.

Optionally, the cavity layer 101 is structured into discrete pixelated regions with lateral dimensions in the XY plane of about 5 μm, wherein each pixel comprises a cavity layer 101 at least partially enveloped in the XY plane by a silicon oxide (SiO₂) cladding layer 107. The SiO₂ cladding functions as a protective barrier and an index-matching layer, reducing optical scattering and reducing the effects of beam waist expansion. In some embodiments, the cladding layer 107 possesses dimensions of about 10 μm along each of the X and Y axes.

Optionally, the cavity layer 101 comprises at least one electrical contact region where the bottom reflector 103 is selectively omitted, thereby exposing the cavity layer 101 for direct electrical connection to an additional conductive layer deposited in the exposed region. Such contact regions enable the deposition of metal electrodes, facilitating the extraction of photogenerated charge carriers. The selective removal of the bottom reflector 103 may be achieved through patterned etching or lithographic techniques, and be limited to localized regions, ensuring minimal impact on the optical resonance conditions within the Fabry-Pérot cavity.

Optionally, the bottom reflector 103 comprises a transparent conductive layer deposited below at least a portion of the cavity layer 101, enabling collection of charge carriers while maintaining optical transparency. The transparent conductive layer may comprise indium tin oxide (ITO), doped zinc oxide (ZnO), or another optically transparent conductive material, selected to ensure minimal optical loss within the operational wavelength range. Optionally, the bottom reflector 103 comprises a conductive oxide layer deposited below at least a portion of the bottom reflector 103, enabling collection of charge carriers while maintaining high optical reflectivity.

Optionally, the cladding layer 107 comprises at least one sidewall electrical contact, enabling lateral charge collection from photogenerated carriers within the cavity layer 101. The lateral dimensions of the cavity layer 101 are configured to ensure that charge diffusion lengths exceed or match the cavity width, enabling efficient charge collection and minimization of recombination losses. The sidewall electrical contacts may comprise metal-semiconductor junctions, doped silicon contacts, or heterostructure interfaces, selected to reduce series resistance and maintain nonlinear optical performance.

Optionally, the top reflector 102 and the bottom reflector 103 each comprise at least 10 dielectric layers, wherein the number of layers selected to achieve a desired reflectivity.

Optionally, each of the first reflector 102 and the second reflector 103 comprises a plurality of dielectric layers 108, 109, forming a high-reflectivity Bragg mirror structure. The dielectric layers are configured to create a periodic refractive index contrast, resulting in constructive interference for reflected waves and destructive interference for transmitted waves at the designed operational wavelengths. This multilayer arrangement ensures high optical reflectivity while minimizing transmission losses, effectively confining light within the cavity layer 101.

Optionally, at least one dielectric layer in the plurality of dielectric layers is selected from the group consisting of titanium dioxide (TiO₂), tantalum pentoxide (Ta₂O₅), silicon nitride (Si₃N₄), and silicon dioxide (SiO₂). These materials are chosen for their high refractive index contrast, low optical absorption, and thermal stability, ensuring stable performance across a range of operating conditions. The selection of dielectric materials is further optimized to achieve desired reflection characteristics and minimal fabrication-induced stress, enhancing the overall optical confinement efficiency of the device.

Optionally, the plurality of dielectric layers are deposited using a deposition method selected from the group consisting of ion beam sputtering (IBS), ion-assisted electron beam deposition (IBAD), atomic layer deposition (ALD), and chemical vapor deposition (CVD), thereby ensuring high uniformity, precise thickness control, and optimal optical performance of the multilayer Bragg mirror structure.

Optionally, the cavity layer 101 absorbs the idler wave 106 via nonlinear optical processes, wherein said processes comprise two-photon absorption and free carrier absorption. The idler wave 106 induces the simultaneous absorption of two photons (in the case of two-photon absorption) or excites carriers directly via free carrier absorption, thereby generating electron-hole pairs in the cavity layer 101, thereby altering the electrical conductivity of the semiconductor, which is then transduced into a respective electrical signal 111.

Optionally, responsive to the input signal wave 104 reaching or exceeding a threshold intensity, the FWM process is initiated, thereby generating an idler wave 106 at a converted wavelength in accordance with energy conservation and phase matching conditions. The generated idler wave 106 is subsequently available for further optical processing or for conversion into an electrical signal 111 as described hereinabove.

Optionally, the detector 100 comprises a lens 112 positioned in its frontal part in the direction of arrival of the signal wave 104.

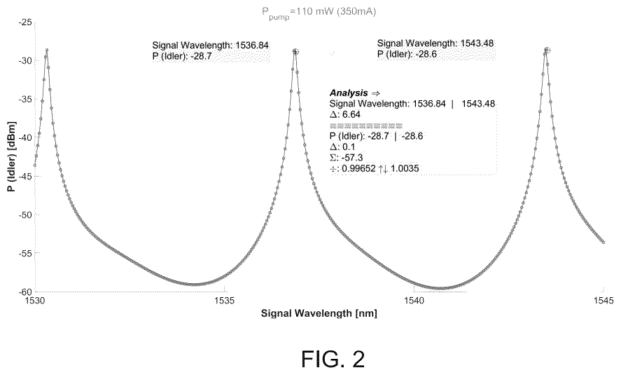

Reference is now made to FIG. 2, illustrating the dependence of idler wave power on the signal wavelength. According to a simulation, the measured idler power exhibits a pronounced periodicity as the signal wavelength is varied. This behavior arises from the resonant nature of the Fabry-Pérot cavity, which strongly enhances the signal at wavelengths corresponding to its FSR. Given a cavity length of 50 μm, the FSR is approximately 6.5 nm, causing the signal to periodically align with the cavity's resonance condition. At these resonant wavelengths, the signal experiences higher field enhancement, which in turn boosts the four-wave mixing process and generates a stronger idler output. As a result, each time the signal wavelength sweeps through a resonance spaced by the FSR, a corresponding peak in idler power is observed.

Optionally, the conversion efficiency is characterized by the overall enhancement factor achieved within the resonant Fabry-Pérot cavity. Experimental measurements indicate that under optimized operating conditions, the enhancement factor attains approximately a value of 730. Reference is now made to Table 1, demonstrating modelling and experimental results:

TABLE 1

| | Mirror Coefficients | Mirror Coefficients Design |
|---|---|---|
| | Measurements | (TiO₂ 160 nm, SiO₂ 250 nm) |
| Pump λ = 1,310 nm | T = 2.4% => R = 97.6% | R = 96.4% => T = 3.6% |
| | r₁ = r₂ = 0.988 | r₁ = r₂ = 0.982 |
| | P_{enc} = 25.5 · P₀ | P_{enc} = 25 · P₀ |
| Signal λ = 1,539.4 nm | T = 4.2% => R = 95.8% | R = 98.4% => T = 1.6% |
| | r₁ = r₂ = 0.979 | r₁ = r₂ = 0.992 |
| | P_{enc} = 15.1 · Pₛ(0) | P_{enc} = 16 · Pₛ(0) |
| Pump λ = 1,140.1 nm | T = 66.9% => R = 33.1% | R = 47.6% => T = 52.4% |
| | r₁ = r₂ = 0.575 | r₁ = r₂ = 0.690 |
| | P_{enc} = 1.9 · Pi^{FWM} | P_{enc} = 2.7 · Pi^{FWM} |
| Performance | Overall Enhancement = 732 | Overall Enhancement = 1,080 |
| | P_{idler} = −39.8 dBm \| 1.0 × 10⁻⁷ W | P_{idler} = −38.2 dBm \| 1.5 × 10−7 W |

Optionally, the conversion efficiency characterized by the ratio of the idler wave output power to the input signal power. Under conditions where the input signal is maintained at a predetermined optical power level and the resonant cavity is configured to align with its FSR (approximately 6.5 nm for a 50 μm cavity), the conversion efficiency is estimated to be on the order of 0.01% to 0.015%. This level of performance is attributable to the high third-order nonlinearity of the silicon layer and the resonant field buildup within the cavity, which collectively enhance the FWM process and minimize propagation losses.

Optionally, the detector 100 is configured to exhibit an intrinsic response time determined by the free carrier lifetime in the cavity layer 101, which is approximately 1 ns. This rapid carrier recombination supports an electrical bandwidth on the order of 1 GHz, thereby enabling high-speed detection and processing of frequency-converted optical signals.

Experimental measurements indicate that a temperature increase from 23° C. to 27° C. induces a wavelength shift of approximately 1 to 2 nm, attributable to changes in the refractive indices of the silicon layer and dielectric mirrors. Optionally, the detector 100 may comprise active temperature control measures such as a thermoelectric cooler to mitigate such temperature-induced variations.

Optionally, the detector 100 is configured for biomedical imaging applications. The system's high sensitivity and enhanced signal-to-noise ratio enable the detection of specific biomarkers, such as hemoglobin, melanin, or other tissue-specific chromophores, by exploiting the spectral absorption features in the SWIR range. This capability facilitates improved contrast imaging for non-invasive diagnostics and early disease detection. The intrinsic compatibility with silicon-based photodetectors further allows for integration into compact imaging modules, thereby supporting applications such as real-time in vivo imaging and tissue spectroscopy.

Optionally, the detector 100 is configured for autonomous vehicle sensing. The design of the detector 100 resonant properties enables intrinsic narrow-band filtering, further enabling robust performance under adverse weather conditions such as for or rain, and in low-light environments. This ensures reliable obstacle detection and environmental mapping for autonomous navigation.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for generating a frequency-converted optical signal from a Short-Wave Infrared (SWIR) input signal wave, comprising:
a three-dimensional resonant optical structure, comprising:
a silicon layer exhibiting third-order nonlinearity (χ(3));
a first reflector and a second reflector, wherein the silicon layer is positioned between the first reflector and the second reflector, thereby forming a resonant cavity configured to support phase-matched nonlinear optical interactions;
a pump generator, configured to generate a coherent electromagnetic pump wave at a controlled wavelength; and
a silicon electro-optical detector,
wherein the input signal wave and the pump wave undergo Four-Wave Mixing (FWM) within the silicon layer, thereby generating an idler wave at a converted wavelength, and
wherein the electro-optical detector converts the idler wave into a corresponding electrical signal via two-photon absorption or free carrier absorption.

2. The system according to claim 1, wherein each of the first reflector and the second reflector comprises a plurality of dielectric layers.

3. The system according to claim 2, wherein at least one dielectric layer in the plurality of dielectric layers is selected from the group consisting of a titanium dioxide layer, tantalum pentoxide layer, silicon nitride layer, and a silicon dioxide layer.

4. The system according to claim 2, wherein each reflector comprises at least 10 dielectric layers, with the number of layers selected to achieve a desired reflectivity.

5. The system according to claim 3, wherein the plurality of dielectric layers are deposited using a method selected from the group consisting of ion beam sputtering (IBS), ion-assisted electron beam deposition (IBAD), atomic layer deposition (ALD), and chemical vapor deposition (CVD).

6. The system according to claim 1, wherein the SWIR input signal wave has a wavelength within a range of 1500 nm to 1850 nm, and the pump wave has a wavelength of 1310 nm.

7. The system according to claim 1, wherein the silicon layer has a thickness of 50 μm.

8. The system according to claim 1, wherein the SWIR input signal wave has a wavelength of approximately 1.55 μm, optimized for optical communication applications.

9. The system according to claim 1, wherein the pump wave has a wavelength within a range of 1000 nm and 1650 nm.

10. The system according to claim 1, wherein the idler wave wavelength is tunable by adjusting the pump wave wavelength.

11. The system according to claim 1, wherein the signal and idler frequencies are configured to align with the longitudinal modes of the optical cavity, thereby enhancing phase matching and nonlinear conversion efficiency.

12. A system for generating a frequency-converted optical signal from a SWIR input signal wave, comprising:
a three-dimensional resonant optical structure, comprising:
a silicon layer exhibiting third-order nonlinearity (χ(3));
a first reflector and a second reflector, wherein the silicon layer is positioned between the first reflector and the second reflector, thereby forming a resonant cavity configured to support phase-matched nonlinear optical interactions,
wherein the input signal wave has sufficient optical power to undergo FWM within the silicon layer without requiring a pump wave, thereby generating an idler wave at a converted wavelength, enabling further processing or detection.

13. A method for generating a frequency-converted optical signal from a SWIR input signal wave, comprising:
providing a three-dimensional resonant optical structure comprising:
a silicon layer exhibiting third-order nonlinearity (χ(3));
a first reflector and a second reflector, wherein the silicon layer is positioned between the first reflector and the second reflector, thereby forming a resonant cavity configured to support phase-matched nonlinear optical interactions;
generating a coherent electromagnetic pump wave at a controlled wavelength using a pump generator;
inputting the SWIR input signal wave and the pump wave into the three-dimensional resonant optical structure;
facilitating FWM within the silicon layer between the input signal wave and the pump wave, thereby generating an idler wave at a converted wavelength; and
converting the idler wave into a corresponding electrical signal with a silicon electro-optical detector via two-photon absorption or free carrier absorption.
